(19) United States
(12) Patent Application Publication
(10) Pub. No.: US 2009/0091307 A1
(43) Pub. Date: Apr. 9, 2009

(54) POWER SUPPLY CIRCUIT AND METHOD FOR ADJUSTING OUTPUT VOLTAGE THEREIN

(75) Inventor: Chien-Feng LAI, Jhubei City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: HOLTEK SEMICONDUCTOR INC., Hsinchu (TW)

(21) Appl. No.: 12/023,164

(22) Filed: Jan. 31, 2008

(30) Foreign Application Priority Data
Oct. 9, 2007 (TW) 096137922

(51) Int. Cl. G05F 1/44; G05F 1/10

(52) U.S. Cl. 323/273; 323/234; 323/265; 323/282

(57) ABSTRACT

A power supply circuit and a method for adjusting an output voltage therein are provided. The power supply circuit includes a regulator having an input terminal receiving an input voltage, an output terminal outputting an output voltage and a regulating terminal, a voltage divider coupled between the output terminal and a ground, generating a dividing voltage, and a gain circuit coupled between the regulating terminal and the voltage divider, receiving the dividing voltage and generating a gain for adjusting the output voltage according to a reference voltage.

### FIELD OF THE INVENTION

The present invention is related to a power supply circuit and an adjusting method therefor, and more particularly to a power supply circuit and a method for adjusting an output voltage therein.

### BACKGROUND OF THE INVENTION

Nowadays, there is a conventional power supply circuit having an adjustable voltage shown in FIG. 1. A power supply circuit 1 includes a regulator 10 and a voltage divider 11, in which the regulator 10 includes an input terminal IN, an output terminal OUT, a regulating terminal ADJ and a ground terminal GND, and the voltage divider 11 includes a first resistor R1 and a second resistor R2. The input terminal IN is used for receiving an input voltage Vi, the output terminal OUT is used for outputting an output voltage Vo, and the ground terminal GND is coupled to a ground. The first resistor R1 is coupled between the output terminal OUT and the second resistor R2. There is a node 12 between the first resistor R1 and the second resistor R2 and the node 12 is coupled to the regulating terminal ADJ. The second resistor R2 is coupled to the ground.

Please refer to FIG. 1. A dividing voltage is generated at the node 12 by the first resistor R1 and the second resistor R2 of the voltage divider 11. Further, the dividing voltage is transferred to the regulating terminal ADJ of the regulator 10, so as to compare the dividing voltage with a reference voltage Vref. Since the dividing voltage is smaller than the reference voltage Vref, the output voltage Vo would be increased. On the contrary, since the dividing voltage is greater than the reference voltage Vref, the output voltage Vo would be decreased.

Moreover, the calculating equation is listed as follows.

$$Vref = Vo \times \frac{R 2}{R 1 + R 2} \\ ⇒ Vo = Vref \times ( 1 + \frac{R 1}{R 2} )$$

According to the mentioned equation, it can be known that the output voltage Vo would be changed since the ratio of the first resistor R1 to the second resistor R2 is changed.

Therefore, while the resistance of the first resistor R1 is relatively much smaller than that of the second resistor R2 (R1<<R2), that is, the ratio of the first resistor R1 over the second resistor R2 is too small to be considered, the lowest output voltage Vo might be equal to the reference voltage Vref. That is to say, if the reference voltage Vref is 1.22V, the lowest output voltage Vo would be 1.22V. In a word, the lowest output voltage Vo is limited to the reference voltage Vref and the use thereof is limited correspondingly.

Furthermore, the mentioned power supply circuit could also be regarded as a small power supply device. In this situation, according to the mentioned description, if the output voltage Vo is adjusted to be lower than the voltage reference or even to approach zero, it is limited for the applied field and not conventional for the further use.

Therefore, the purpose of the present invention is to develop a power supply circuit and a method for adjusting an output voltage therein to deal with the above situations encountered in the prior art.

### SUMMARY OF THE INVENTION

It is therefore a first aspect of the present invention to provide a power supply circuit and a method for adjusting an output voltage therein, in which the output voltage would be adjusted to be lower than a voltage reference by a negative feedback mechanism constituted of a gain circuit.

It is therefore a second aspect of the present invention to provide a power supply circuit and a method for adjusting an output voltage therein to compare the gain with the reference voltage and thereby adjusting the output voltage to approach zero.

According to a third aspect of the present invention, a power supply circuit is provided. The power supply circuit includes a regulator having an input terminal receiving an input voltage, an output terminal outputting an output voltage and a regulating terminal, a voltage divider coupled between the output terminal and a ground, generating a dividing voltage, and a gain circuit coupled between the regulating terminal and the voltage divider, receiving the dividing voltage and generating a gain for adjusting the output voltage according to a reference voltage.

Preferably, the gain circuit includes an operational amplifier, an input resistor and a feedback resistor, the operational amplifier has a non-inverting input, an inverting input and an amplifier output, the input resistor is coupled between the inverting input and the ground, and the feedback resistor is coupled between the inverting input and the amplifier output.

Preferably, the ratio of the feedback resistor to the input resistor is adjusted so as to adjust the gain to regulate the output voltage.

Preferably, the voltage divider includes a first and a second resistors coupled to a node in series, the first resistor is coupled to the output terminal, the second resistor is coupled to the ground, and the node is coupled to the gain circuit for outputting the dividing voltage.

Preferably, the output voltage is equal to the voltage reference while the resistance of the feedback resistor is relatively much smaller than that of the input resistor and the resistance of the first resistor is relatively much smaller than that of the second resistor.

Preferably, the resistance of the first resistor is equal to that of the second resistor.

Preferably, the feedback resistor is a variable resistor and the resistance of the variable resistor is adjusted to control the output voltage.

Preferably, the output voltage is adjusted to approach zero.

Preferably, the gain circuit includes at least one transistor which is one selected from a group consisting of a bipolar junction transistor (BJT), a metal oxide semiconductor field-effect transistor (MOSFET) and a junction field-effect transistor (JFET).

Preferably, the gain circuit includes one of at least one micro control unit (MCU) and at least one analogue multiplier.

Preferably, the regulator is a linear regulator or a switching regulator, and the linear regulator is a low dropout regulator (LDO) and the switching regulator is a step-down regulator.

According to a fourth aspect of the present invention, a method for adjusting an output voltage in a power supply circuit is provided. The method includes steps of providing a regulator having an input terminal for receiving an input voltage, an output terminal and a regulating terminal, determining a reference voltage, providing a gain circuit coupled between the output terminal and the regulating terminal and generating a gain, and adjusting the gain so as to adjust the output voltage.

Preferably, the method further includes a step of providing a voltage divider coupled between the output terminal and the gain circuit and generating a dividing voltage to adjust the gain.

Preferably, the gain circuit includes an operational amplifier, an input resistor and a feedback resistor, the operational amplifier has a non-inverting input, an inverting input and an amplifier output, the input resistor is coupled between the inverting input and a ground, and the feedback resistor is coupled between the inverting input and the amplifier output.

Preferably, the ratio of the feedback resistor to the input resistor is adjusted so as to adjust the gain, by which the output voltage is adjusted accordingly to approach zero.

According to a fifth aspect of the present invention, a method for adjusting an output voltage in a power supply circuit is provided. The method includes steps of providing a regulator having an input terminal for receiving an input voltage, an output terminal and a regulating terminal, determining a reference voltage, providing an operational amplifier coupled between the output terminal and the regulating terminal, wherein the operational amplifier has a non-inverting input, an inverting input and an amplifier output, providing an input resistor coupled between the inverting input and a ground, and a feedback resistor coupled between the inverting input and the amplifier output, and generating a variation of a gain by adjusting the ratio of the feedback resistor over the input resistor so as to compare the gain with the reference voltage and thereby adjusting the output voltage.

Preferably, the output voltage is adjusted to be lower than the voltage reference.

According to a sixteenth aspect of the present invention, a power supply circuit is provided. The power supply circuit includes a regulator having an input terminal receiving an input voltage, an output terminal outputting an output voltage and a regulating terminal, a first resistor coupled to the output terminal, a second resistor coupled to the first resistor at a node and coupled to a ground, an operational amplifier coupled between the regulating terminal and the node and having a non-inverting input, an inverting input and an amplifier output, an input resistor coupled between the inverting input and the ground, and a feedback resistor coupled between the inverting input and the amplifier output, thereby adjusting the ratio of the feedback resistor over the input resistor to generate a gain so as to adjust the output voltage.

Preferably, the output voltage is adjusted to approach zero.

The above contents and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 is a schematic view showing a power supply circuit according to the prior art;

FIG. 2 is a schematic view showing a power supply circuit and a method for adjusting the output voltage therein according to a preferred embodiment of the present invention;

FIG. 3 is a schematic view showing a concrete circuit structure of FIG. 2;

FIGS. 4(A) and 4(B) are respective schematic diagrams illustrating respective relative curves by performing a circuit simulation according to the preferred embodiment of the present invention;

FIGS. 5(A) and (B) are respective schematic views showing a bipolar junction transistor (BJT) and a metal oxide semiconductor field-effect transistor (MOSFET) applied in the present gain circuit of the present invention.

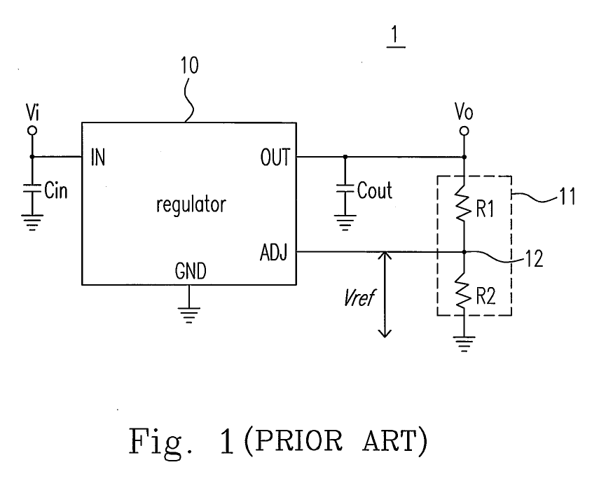

### DETAILED DESCRIPTION OF THE PREFERRED EMBODIMENTS

The present invention will now be described more specifically with reference to the following embodiment. It is to be noted that the following descriptions of preferred embodiment of this invention are presented herein for purposes of illustration and description only; it is not intended to be exhaustive or to be limited to the precise form disclosed.

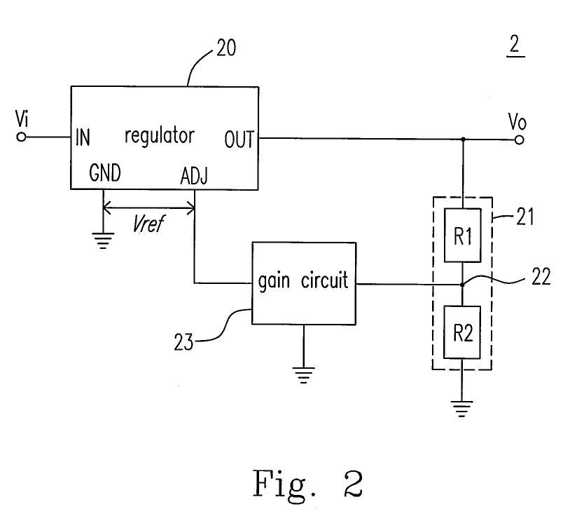

Please refer to FIG. 2, which is a schematic view showing a power supply circuit and a method for adjusting the output voltage therein according to a preferred embodiment of the present invention. A power supply circuit 2 includes a regulator 20, a voltage divider 21 and a gain circuit 23. The regulator 20 includes an input terminal IN, an output terminal OUT, a regulating terminal ADJ and a ground terminal GND, in which the input terminal IN is used for receiving an input voltage Vi, the output terminal OUT is used for outputting an output voltage Vo, and the ground terminal GND is coupled to a ground. Further, the voltage divider 21 is coupled between the output terminal OUT and the ground, and the voltage divider 21 includes a first resistor R1 and a second resistor R2, the first resistor R1 and the second resistor R2 are coupled between the output terminal OUT and the ground in series. Besides, there is a node 22 between the first resistor R1 and the second resistor R2 for outputting a dividing voltage according to the output voltage Vo. The gain circuit 23 is coupled between the regulating terminal ADJ and the node 22. The gain circuit 23 is used for receiving the dividing voltage from the voltage divider 21 to generate a gain for adjusting the output voltage Vo according to a reference voltage Vref, and then the output voltage Vo is transferred to the regulating terminal ADJ. That is the following equation.

$$Vo = Vref \times ( 1 + \frac{R 1}{R 2} ) \times G$$

where G is the gain, and Vref is the reference voltage of the power supply circuit 2.

Thus, a feedback voltage is generated from the voltage divider 21 by adjusting the gain (G) of the gain circuit 23 and is transferred to the regulating terminal ADJ. While the feedback voltage is smaller than the reference voltage Vref, the output voltage Vo would be increased. Further, while the feedback voltage is greater than the reference voltage Vref, the output voltage Vo would be decreased. Therefore, the purpose for controlling the output voltage Vo could be effectively achieved. The output voltage Vo could be adjusted to be lower than the reference voltage Vref, and further to approach zero.

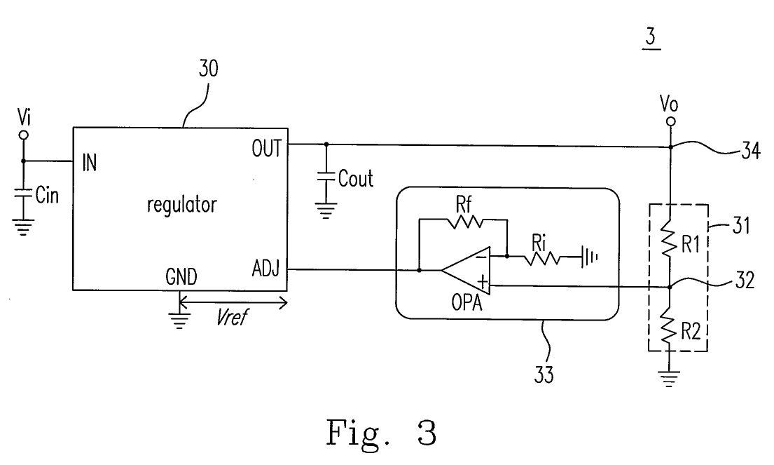

Please refer to FIG. 3, which is a schematic circuit diagram of the power supply circuit in FIG. 2. The basic circuit structure of a power supply circuit 3 in FIG. 3 is similar to that of the power supply circuit 2 in FIG. 2. Accordingly, the power supply circuit 3 includes a regulator 30, a voltage divider 31 and a gain circuit 33. Further, the difference between the power supply circuit 2 and the power supply circuit 3 is that the power supply circuit 3 includes an input resistor Ri, a feedback resistor Rf and an operational amplifier OPA. In addition, the operational amplifier OPA has a non-inverting input, an inverting input and an amplifier output, the input resistor Ri is coupled between the inverting input and the ground, and the feedback resistor Rf is coupled between the inverting input and the amplifier output. The feedback resistor Rf is coupled to the input resistor Ri in series, the non-inverting input is coupled to a node 32 of the voltage divider 31, and the amplifier output of the operational amplifier OPA is coupled to a regulating terminal ADJ of the regulator 30. Accordingly, the ratio of the feedback resistor Rf over the input resistor Ri would be adjusted so as to generate a variation of a gain (g) from the gain circuit 33 to feedback the regulating terminal ADJ thereby control an output voltage of the regulator 30.

The concrete calculating process is as following.

$$Vref = Vo \times \frac{R 2}{R 1 + R 2} \times ( 1 + \frac{Rf}{Ri} ) \\ ⇒ Vo = Vref \times \frac{( 1 + \frac{R 1}{R 2} )}{( 1 + \frac{Rf}{Ri} )}$$

$$if Rf = R 1 , Ri = R 2 , \\ then Vo = Vref$$

Accordingly, if Rf<<Ri, the value of Rf/Ri could be ignored. Thus, the maximum output voltage Vo would be determined based on the ratio of the first resistor R1 to the second resistor R2 in the voltage divider 31. Then, the minimum output voltage Vo would be determined by adjusting the ratio of the feedback resistor Rf over the input resistor Ri. Furthermore, if the resistance of the first resistor is equal to that of the second resistor, the output voltage could be controlled by adjusting the resistance of the feedback resistor Rf. Thus, the feedback resistor Rf can be a variable resistor.

Moreover, the present regulator (20, 30) could be various regulators for step down. Specifically, the present regulator (20, 30) can be a linear regulator, such as a low dropout regulator (LDO), and a switching regulator, such as a step-down regulator.

### Experiment Example

The present power supply circuit is exemplarily the low dropout regulator (LDO) whose type is LT1761SD. The present power supply circuit includes an adjustable output voltage (Vo), and the related specification thereof is as follows.

The maximum input voltage Vi(max)=20V, the maximum output voltage Io(max)=100 mA, the minimum dropout voltage (Io=100 mA)≦0.5V, and the reference voltage Vref(typ.)=1.22V.

Thus, the present invention could provide the adjustable range of the output voltage Vo from 10V to 0.05V according to the mentioned description. The concrete calculating process is as following.

A first step is:

$$∵ Vo ( max ) = 10 V ∴ 10 V = 1.22 V \times ( 1 + \frac{R 1}{R 2} ) \\ ⇒ \frac{R 1}{R 2} ≅ 7.2$$

Set R2=10K, then R1=72K

Then, a second step is:

$$∵ Vo ( min ) = 0.05 V ∴ 0.05 V = 1.22 V \times \frac{1 + \frac{72 K}{10 K}}{1 + \frac{Rf}{10 K}} \\ ⇒ Rf = 1.99 Meg$$

Accordingly, the feedback resistor Rf could be a variable resistor (potentiometer) of 2 Meg, and the output voltage Vo can be adjusted by adjusting the resistance of the variable resistor Rf as the small power supply device.

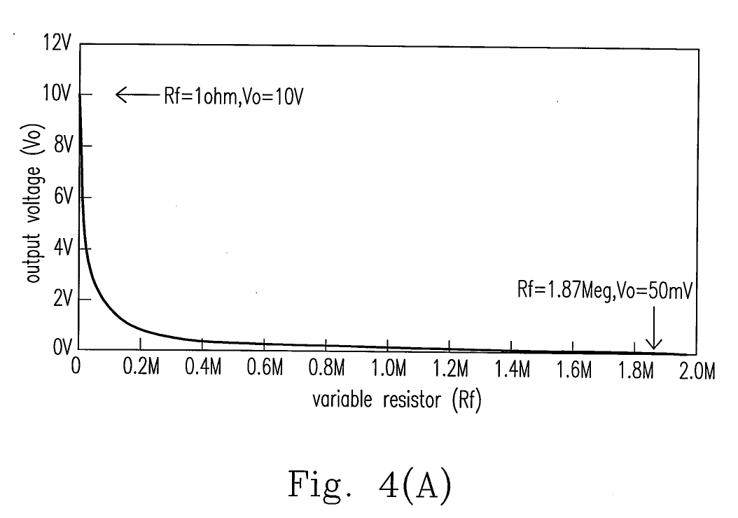

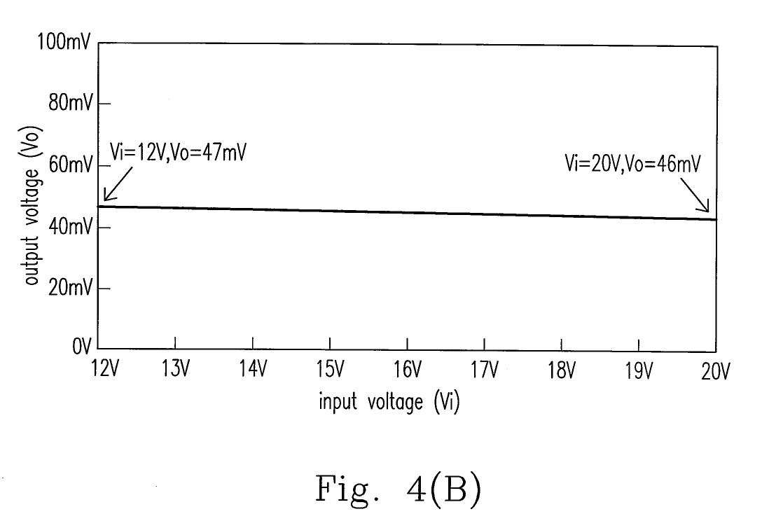

Further, a circuit simulation for the power supply circuit 3 of FIG. 3 would be implemented based on the mentioned data, and the detection position for detecting circuit's variables is a connection 34 in FIG. 3. Please refer to FIG. 4(A), which is a diagram illustrating the relation between a variable resistor Rf and a output voltage Vo. According to FIG. 4(A), it is obvious that the variable resistor Rf is gradually increased and the output voltage Vo is decreased correspondingly. Further, the variation of the curve slope in FIG. 4(A) is gradually gentle along the increased resistance of the variable resistor Rf. Then, while the variable resistor Rf is increased to be 1.87 Meg, the output voltage Vo could be decreased to be 50 mV (0.05V). Moreover, FIG. 4(B) is a diagram illustrating the relation between an input voltage Vi and an output voltage Vo. It is obvious that the output voltage could be kept between 46 mV and 47 mV even if the input voltage Vi is increased from 12V to 20V. Therefore, according to FIGS. 4(A) and 4(B), it would be understood that the present invention could provide a negative feedback mechanism constituted of a gain circuit, thereby adjusting the output voltage Vo to approach zero.

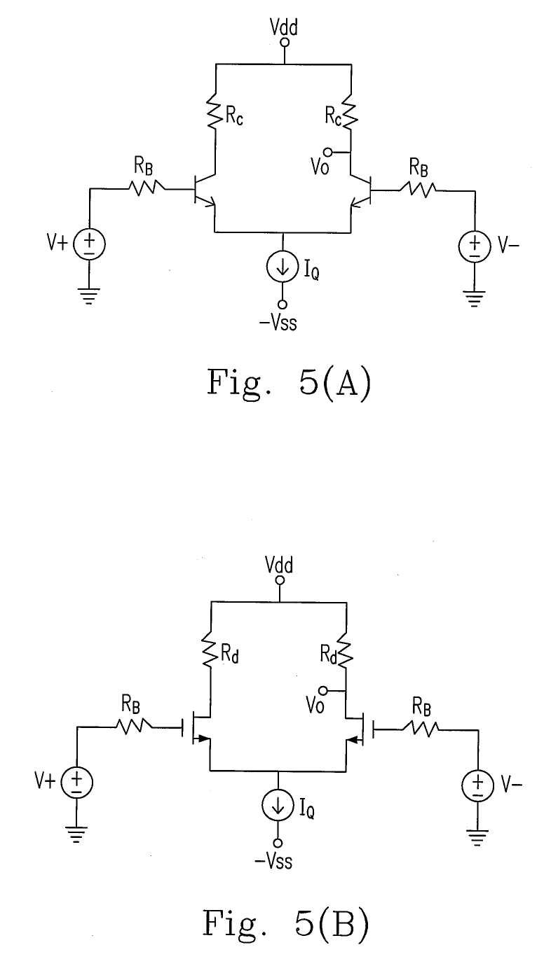

Furthermore, in addition to the mentioned operational amplifier OPA, the present gain circuit could be implemented by any electrical components which provide a gain feedback, such as the transistor, the analogue multiplier or micro control unit (MCU). Please refer to FIGS. 5(A) and 5(B). The transistor could be a bipolar junction transistor (BJT) as shown in FIG. 5(A), a metal oxide semiconductor field-effect transistor (MOSFET) as shown in FIG. 5(B), or a junction field-effect transistor (JFET). Since the gain circuit constituted of the mentioned electrical components includes a variation of the gain to feedback to the regulating terminal ADJ of the regulator so as to compare the gain with the reference voltage, and thereby adjusting the output voltage Vo to be lower than the voltage reference and further approach zero.

In conclusion, it is understood that the present power supply circuit and the present method for adjusting an output voltage therein could provide a gain circuit coupled between a voltage divider and a regulator, thereby generate a gain for adjusting the output voltage according to a reference voltage. Further, a variation of the gain would be generated by adjusting the ratio of the resistances of resistors in the gain circuit to feedback to the regulating terminal, so as to compare the gain with the reference voltage and thereby adjusting the output voltage to be lower than the reference voltage. In addition, the output voltage further could be adjusted to approach zero. Moreover, the present invention could be applied in various step-down regulators and provides more convenience in the related field.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A power supply circuit, comprising:
a regulator having an input terminal receiving an input voltage, an output terminal outputting an output voltage and a regulating terminal;
a voltage divider coupled between the output terminal and a ground, generating a dividing voltage; and
a gain circuit coupled between the regulating terminal and the voltage divider, receiving the dividing voltage and generating a gain for adjusting the output voltage according to a reference voltage.

2. The power supply circuit according to claim 1, wherein the gain circuit includes an operational amplifier, an input resistor and a feedback resistor, the operational amplifier has a non-inverting input, an inverting input and an amplifier output, the input resistor is coupled between the inverting input and the ground, and the feedback resistor is coupled between the inverting input and the amplifier output.

3. The power supply circuit according to claim 2, wherein the ratio of the feedback resistor to the input resistor is adjusted so as to adjust the gain to regulate the output voltage.

4. The power supply circuit according to claim 2, wherein the voltage divider includes a first and a second resistors coupled to a node in series, the first resistor is coupled to the output terminal, the second resistor is coupled to the ground, and the node is coupled to the gain circuit for outputting the dividing voltage.

5. The power supply circuit according to claim 4, wherein the output voltage is equal to the voltage reference while the resistance of the feedback resistor is relatively much smaller than that of the input resistor and the resistance of the first resistor is relatively much smaller than that of the second resistor.

6. The power supply circuit according to claim 4, wherein the resistance of the first resistor is equal to that of the second resistor.

7. The power supply circuit according to claim 6, wherein the feedback resistor is a variable resistor and the resistance of the variable resistor is adjusted to control the output voltage.

8. The power supply circuit according to claim 7, wherein the output voltage is adjusted to approach zero.

9. The power supply circuit according to claim 1, wherein the gain circuit includes at least one transistor which is one selected from a group consisting of a bipolar junction transistor (BJT), a metal oxide semiconductor field-effect transistor (MOSFET) and a junction field-effect transistor (JFET).

10. The power supply circuit according to claim 1, wherein the gain circuit includes one of at least one micro control unit (MCU) and at least one analogue multiplier.

11. The power supply circuit according to claim 1, wherein the regulator is a linear regulator, and the linear regulator is a low dropout regulator (LDO).

12. The power supply circuit according to claim 1, wherein the regulator is a switching regulator, and the switching regulator is a step-down regulator.

13. A method for adjusting an output voltage in a power supply circuit, comprising steps of:
providing a regulator having an input terminal for receiving an input voltage, an output terminal and a regulating terminal;
determining a reference voltage;
providing a gain circuit coupled between the output terminal and the regulating terminal and generating a gain; and
adjusting the gain so as to adjust the output voltage.

14. The method according to claim 13 further comprising a step of providing a voltage divider coupled between the output terminal and the gain circuit and generating a dividing voltage to adjust the gain.

15. The method according to claim 13, wherein the gain circuit includes an operational amplifier, an input resistor and a feedback resistor, the operational amplifier has a non-inverting input, an inverting input and an amplifier output, the input resistor is coupled between the inverting input and a ground, and the feedback resistor is coupled between the inverting input and the amplifier output.

16. The method according to claim 15, wherein the ratio of the feedback resistor to the input resistor is adjusted so as to adjust the gain, by which the output voltage is adjusted accordingly to approach zero.

17. A method for adjusting an output voltage in a power supply circuit, comprising the steps of:
providing a regulator having an input terminal for receiving an input voltage, an output terminal and a regulating terminal;
determining a reference voltage;
providing an operational amplifier coupled between the output terminal and the regulating terminal, wherein the operational amplifier has a non-inverting input, an inverting input and an amplifier output;
providing an input resistor coupled between the inverting input and a ground, and a feedback resistor coupled between the inverting input and the amplifier output; and
generating a variation of a gain by adjusting the ratio of the feedback resistor over the input resistor so as to compare the gain with the reference voltage and thereby adjusting the output voltage.

18. The method according to claim 17, wherein the output voltage is adjusted to be lower than the voltage reference.

19. A power supply circuit, comprising:
a regulator having an input terminal receiving an input voltage, an output terminal outputting an output voltage and a regulating terminal;
a first resistor coupled to the output terminal;
a second resistor coupled to the first resistor at a node and coupled to a ground;
an operational amplifier coupled between the regulating terminal and the node and having a non-inverting input, an inverting input and an amplifier output;
an input resistor coupled between the inverting input and the ground; and
a feedback resistor coupled between the inverting input and the amplifier output, thereby adjusting the ratio of the feedback resistor over the input resistor to generate a gain so as to adjust the output voltage.

20. The power supply circuit according to claim 19, wherein the output voltage is adjusted to approach zero.
